(19) United States
(12) Patent Application Publication
(10) Pub. No.: US 2013/0087336 A1
(43) Pub. Date: Apr. 11, 2013

(54) System And Method Of Perforating A Well And Preparing A Perforating Fluid For The Same

(71) Applicant: David R. Underdown, Conroe, TX (US)

(72) Inventor: David R. Underdown, Conroe, TX (US)

(73) Assignee: Chevron U.S.A. Inc., San Ramon, CA (US)

(21) Appl. No.: 13/253,380

(22) Filed: Oct. 5, 2011

(51) Int. Cl. E21B 43/11; C09K 8/60

(52) U.S. Cl. 166/298; 166/55; 507/200

(57) ABSTRACT

A perforation fluid is prepared having a solid material suspended in a liquid. The solid material includes particles having particle sizes that correspond to the pore throat sizes of one or more geological formations through which a well to be perforated runs. The solid material is self-degrading. Perforation of a well-casing of the well in the perforation fluid causes the solid material to instantaneously (or substantially so) form a self-degrading filter cake that facilitates setting of the final completions of the well.

### FIELD

The disclosure relates to fluid control in a petrochemical well after perforation through the use of a perforation fluid containing solid particles that are particularly sized and self-degrading.

### BACKGROUND

A perforation in the context of petrochemical wells may refer to a hole punched in a well-casing of a petrochemical well to connect it to the reservoir. In cased hole completions, the well will be drilled down past the section of the formation desired for production and will have casing or a liner run in and cemented in place separating the formation from the well bore. Before the final completions are set one or more perforation guns may be lowered down to the desired depth(s) and fired to perforate the well-casing. A typical perforating gun can carry many dozens of charges.

The benefits of this strategy include but are not limited to allowing precise selection of where in the formation production will be and to be able to seal off perforations, which are no longer useful or counterproductive, through cementing or straddling.

A drawback associated with conventional perforating operations is the extent of formation damage caused by fluid loss pills applied after the perforating event if excessive fluid losses occur. In a typical perforating operation, the perforating event is conducted in a “non-damaging” fluid such as brine. Once the perforating event occurs, a good indication of successfully connecting to the reservoir is the loss of the brine in the wellbore to the reservoir. If excessive fluid loss occurs, it is common practice to establish well control by placement of a fluid loss pill into the wellbore. The fluid loss pill can contain polymeric material such as CMHEC or XC, or a combination of polymeric material and sized solid material such as calcium carbonate. The pill controls fluid loss by polymeric invasion of the formation around the perforation tunnel, formation of an impermeable filter cake on the face of the perforation tunnel or a combination of both. Fluid loss control in this manner can result in significant formation damage.

Removal of the fluid loss pill is attempted by a number of means. In some cases, the reservoir fluids are flowed back to surface in an effort to try to remove the components of the fluid loss pill from the perforation tunnel and near tunnel formation. However, if it is not possible to flow the fluids to the surface or there is a concern about the extent of removal of the pill, it common practice to make an effort to remove the fluid loss pill components chemically. One approach is by pumping into the wellbore a chemical such as an acid, oxidative breaker or enzyme called a “breaker” to react and decompose the components of the fluid loss pill depending on the type of fluid loss pill used. This practice takes time and complete removal of the fluid loss pill is not always accomplished due to chemicals pumped into the wellbore not contacting the entire fluid loss pill. If only a portion of the filter cake is removed the breaker can flow through the area where the filter cake is removed without making substantial contact with the rest of the filter cake.

Other drawbacks with conventional techniques for perforation and/or fluid control exist.

### SUMMARY

One aspect of the disclosure relates to a method of perforating a well-casing in a well created for the extraction of petrochemical fluid. In some embodiments, the method comprises obtaining a perforation fluid comprising solid particles suspended in a liquid, wherein the solid particles (i) having sizes that correspond to pore throat sizes of one or more geological formations through which the well-casing runs, and (ii) made up of a hydrolyzable material; pumping the perforation fluid into a section of the well-casing that is to be perforated; positioning a series of perforating guns containing shape charges within the perforation fluid such that detonation of the shape charges will create perforations in the well-casing to communicate the interior of the well-casing with the reservoir formation rock ; controlling pressure within the well-casing such that the perforation fluid flows into the perforations, thereby causing the solid particles in the perforating fluid to plug the pores in the one or more geological formations on the exterior of the well-casing; sealing the completions within the well as the solid particles undergo hydrolysis; and extracting petrochemical fluids through the perforations after the solid particles have undergone hydrolysis.

Another aspect of the disclosure relates to a system configured to perforate a well-casing in a well created for the extraction of petrochemical fluid. In some embodiments, the system comprises one or more of a pump subsystem, a perforation gun, a wellhead, and a petrochemical extraction sub-system. The pump subsystem is configured to pump a perforation fluid into a section of the well-casing that is to be perforated, the perforation fluid comprising solid particles suspended in a liquid. The solid particles (i) have sizes that correspond to pore throat sizes of one or more geological formations through which the well-casing runs, and (ii) are made up of a hydrolyzable material. The perforation gun is positioned within the perforation fluid such that detonation of a set of charges carried by the perforation gun will create perforations in the well-casing to communicate the interior of the well-casing with the exterior of the well-casing. The wellhead is configured to control pressure within the well-casing such that the perforation fluid flows into the perforations subsequent to detonation of the charges cause the solid particles to plug the pores in the one or more geological formations on the exterior of the well-casing as completions are set within the well. The petrochemical extraction sub-system is configured to extract petrochemical fluid through the perforations after the solid particles have undergone hydrolysis.

Yet another aspect of the invention relates to a method of creating a perforation fluid to be used in perforation of a well-casing in a well created for the extraction of petrochemical fluid. In some embodiments, the method comprises obtaining pore throat sizes of one or more geological formations through which the well-casing runs; determining a set of one or more particle sizes that correspond to the pore through sizes; and suspending solid particles in a liquid, wherein the solid particles (i) have the determined one or more particle sizes, and (ii) are made up of a hydrolyzable material.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a method of providing a perforation fluid and/or perforating a well-casing in a well created for the extraction of petrochemical fluid.

FIG. 2 illustrates a perforation gun in position to perform a well perforation.

FIG. 3 illustrates a well perforation.

FIG. 4 illustrates a perforation fluid flowing into newly formed perforations within a well.

FIG. 5 illustrates degradation of a filter cake formed on perforation walls.

FIG. 6 illustrates a system configured to perforate a well-casing in a well created for the extraction of petrochemical fluid.

### DETAILED DESCRIPTION

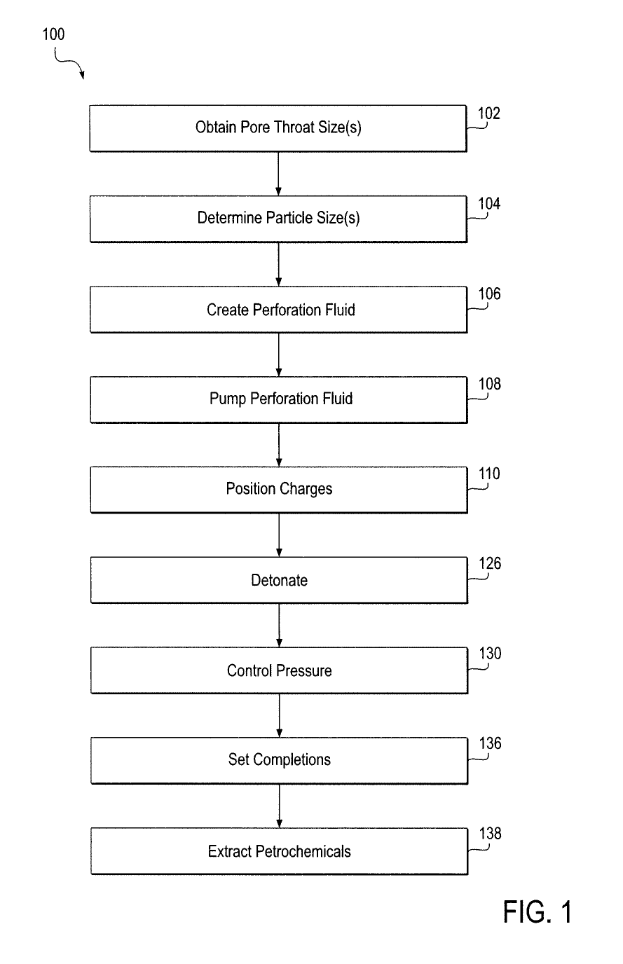

FIG. 1 illustrates a method 100 of providing a perforation fluid and/or perforating a well-casing in a well created for the extraction of petrochemical fluid. The operations of method 100 presented below are intended to be illustrative. In some embodiments, method 100 may be accomplished with one or more additional operations not described, and/or without one or more of the operations discussed. Additionally, the order in which the operations of method 100 are illustrated in FIG. 1 and described below is not intended to be limiting.

At an operation 102, information is obtained related to the pore throat size of one or more geological formations through which the well is formed. Such information may include, for example a plot of average pore throat size as a function of percent total pore throats, average pore throat size, a range of pore throat sizes, and/or other information related to pore throat size. Obtaining this information may include determining such information, accessing such information from electronic storage, receiving such information over a network (or other communications) connection, and/or other mechanisms for obtaining such information. The information related to pore throat size may be determined based on measurements using porosimetry. This is a technique used to determine pore diameter, total pore volume and/or surface area. The technique may involve intrusion of mercury at high pressure into a material. The pore size can be determined based on the pressure needed to force the liquid into a pore. Other techniques for measuring pore throat size are contemplated.

At an operation 104, a particle size (or sizes) are determined based on the pore throat sizes are determined at operation 102. The particle size(s) are determined such that the particles having the determined size(s) will bridge the pore throats of the geological formations through which the well is formed. The amount and particle size(s) may be determined based on bridging theory. For example, a computer program may be used to compute the distribution of particles sizes and quanity of sized particles required to form a bridge on the distribution of pore throat sizes as determined using mercury porosimetry.

At an operation 106, a perforation fluid is created. The perforation fluid is a liquid in which solid particles having the particle size(s) determined at operation 104 are suspended. The liquid may include, for example, potassium choride (KCl), sodium chloride (NaCl), or calcium bromide (CaBr₂) brines containing polymers such as hydroxyethylcelluose (HEC), starch, and xanthan gum polymers (XC), and/or other liquids. The solid particles are formed from a hydrolyzable substance. Such substances may include, for example, acid precursors that self-degrade over time. By way of non-limiting example, the solid particles may be formed from one or more of lactide, glycolide, polylactic acid, copolymers of glycolic acid that self degrade, and/or other self-degrading substances. Creating the perforation fluid may include one or more of obtaining the solid particles, obtaining the liquid, mixing the solid particles and the liquid, and/or other operations. In some embodiments, the perforation fluid having solid particles with the determined particle size(s) are obtained from a distributor, rather than being created through mixing and/or other means.

In some embodiments, the solid particles are substantially the only solid materials in the perforation fluid. In some embodiments, other solid materials are included in the perforation fluid. The other solid materials may be particulate (e.g., having the determined particle sizes). The other solid materials may be materials that are dissolved by the acids formed by the solid material through hydrolysis. Such materials may include, for example, calcium carbonate, and magnesium oxide, and/or other materials. The solid particles may be the primary solid material in the perforation fluid. By way of non-limiting example, the ratio of volume of the solid particles to the volume of all solids in the perforation fluid may be about 10/10, about 9.5/10, about 9/10, about 8/10, and/or other ratios.

At an operation 108, the perforation fluid is pumped into a section of the well that is to be perforated. The perforation may be delivered in a perforation “pill” to the well section through a wellhead, and/or at other points in the well. The pressure within the well may be controlled at operation 108 such that the pressure within the section of the well to be perforated is maintained at some predetermined level. The predetermined level can be a level at which the pressure within the well is greater than the pressure outside the well so that the perforation fluid will flow into perforations in the well casing.

At an operation 110, a series of charges are positioned within the perforation fluid inside the well. The series of charges may be carried, for example, by a perforation gun. The charges are positioned inside the well such that detonation of the charges will perforate the well-casing to connect the interior of the well-casing with the formation/reservoir with is exterior of the well-casing.

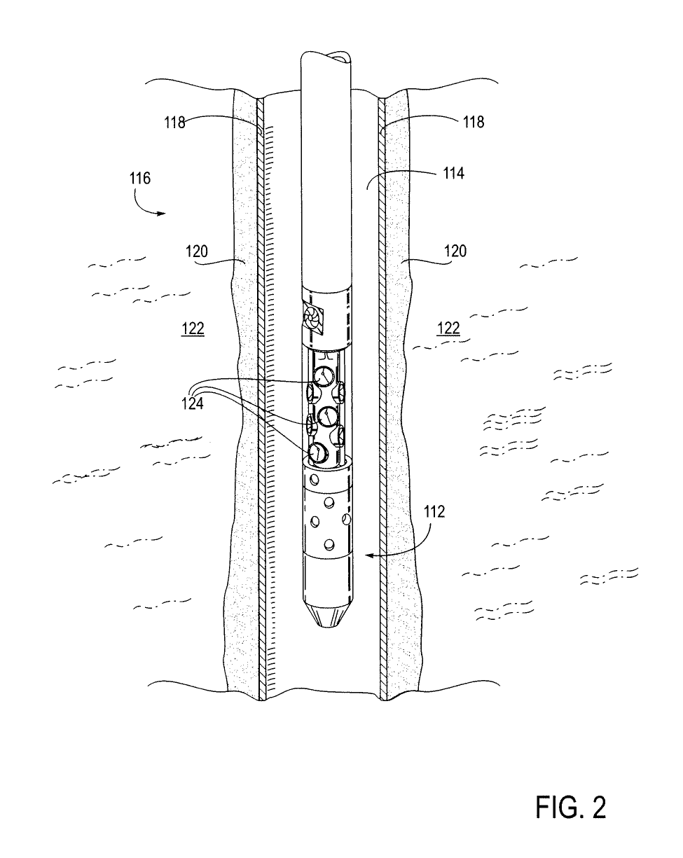

By way of illustration, FIG. 2 depicts a perforation gun 112 disposed within a pill of perforation fluid 114 that has been pumped in a section of a well 116 to be perforated. Well 116 is formed in part by a well-casing 118 that is encased in a layer of cement 120. Well 116 runs through one or more geological formations 122. The perforation gun 112 carries a series of explosive charges 124. The explosive charges 124 are shaped such that detonation of the explosive charges 124 will perforate well-casing 118 and cement 120. Depiction herein (in FIG. 2 and/or other drawings in the present disclosure) of perforation gun 112 as including a single gun is not intended to be limiting. In some embodiments, some or all of the functionality attributed to the single perforation gun 112 depicted in the drawings may be performed by a plurality of perforation guns.

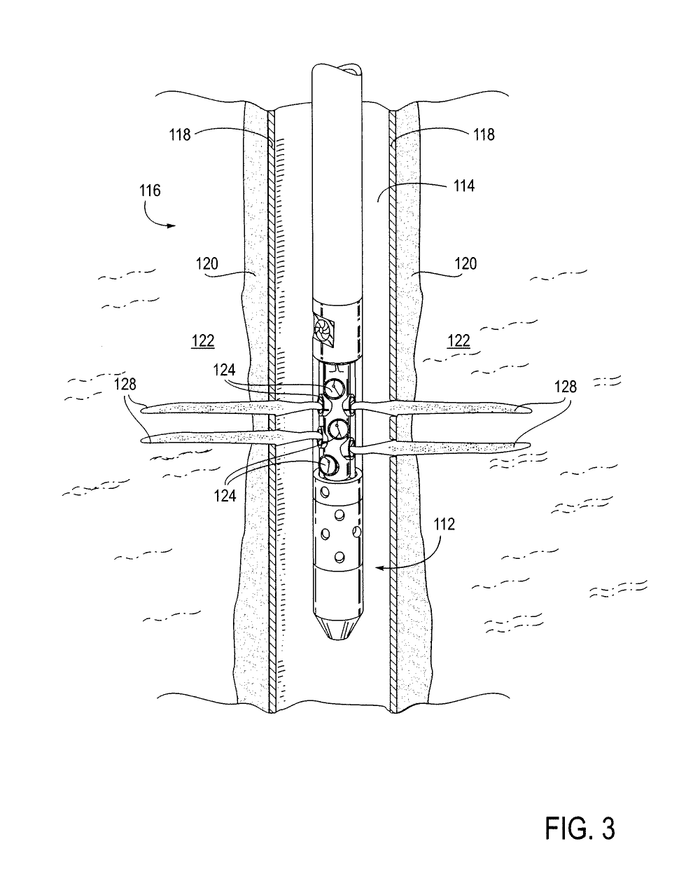

Turning back to FIG. 1, at an operation 126, the shape charges positioned at operation 110 are detonated. Such detonation may be initiated via communication with the charges (and/or an attached detonator) from a controller. The communication may be provided to the shape charges via wired and/or wireless communication media. Detonation of the shape charges creates perforations in the well-casing. By way of illustration, FIG. 3 depicts detonations 128 of shape charges 124, and shows such detonations 128 perforating well-casing 118 and cement 120.

Returning to FIG. 1, at an operation 130, pressure within the well is controlled such that the perforation fluid flows through the perforations in the well caused by operation 126. This flow of perforation fluid causes the solid particles to form a filter cake on the perforation walls, thereby staunching such flow. The staunching of the flow of perforation fluid through the perforations by the filter cake provides fluid control within the well that facilitates further operations being performed on the well without excessive fluid being pumped or lost into the geological formations surrounding the well.

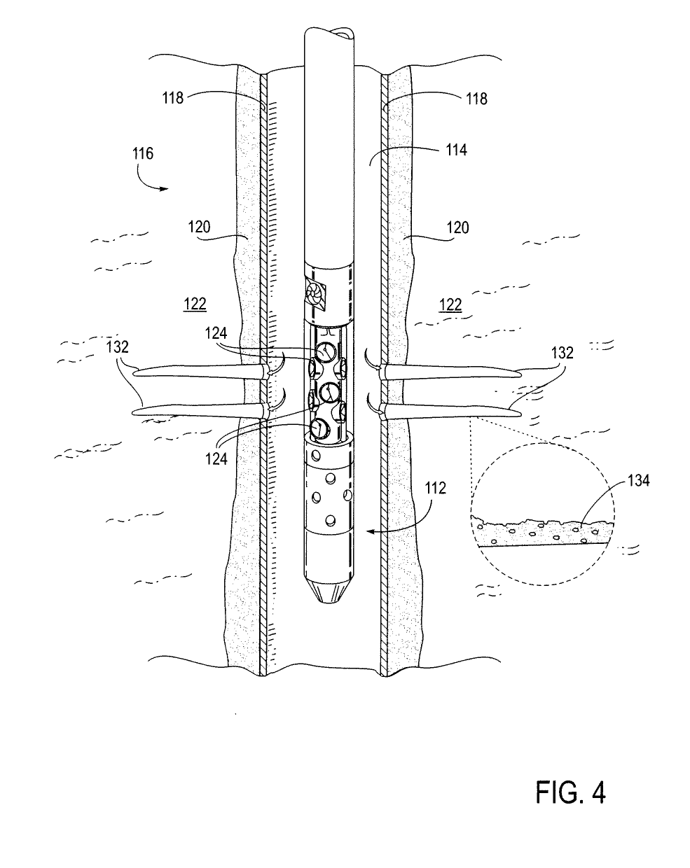

By way of illustration, FIG. 4 depicts the flow of perforation fluid 114 into perforations 132 in well 116. As can be see in FIG. 4, this flow creates filter cakes 134 to be formed within perforations 132 to staunch further flow of perforation fluid 114 out of perforations 132.

Referring back to FIG. 1, at an operation 136, completions are set in the well. Operation 136 may include removing the perforation gun that carried the charges. The completions that are set at operation 136 may include upper completions, lower completions, and/or other completions. The completions are set while the filter cake created at operation 130 by the solid particles is still in tact.

At an operation 138, petrochemical fluids are extracted through the perforations after the solid particles have degraded through hydrolysis. After the perforation is performed at operations 126 and 130, the solid particles in the perforation fluid begin to undergo hydrolysis. As this occurs, the filter cake is slowly reduced through hydrolysis until the perforations are substantially open and extraction through the perforations can commence at operation 138.

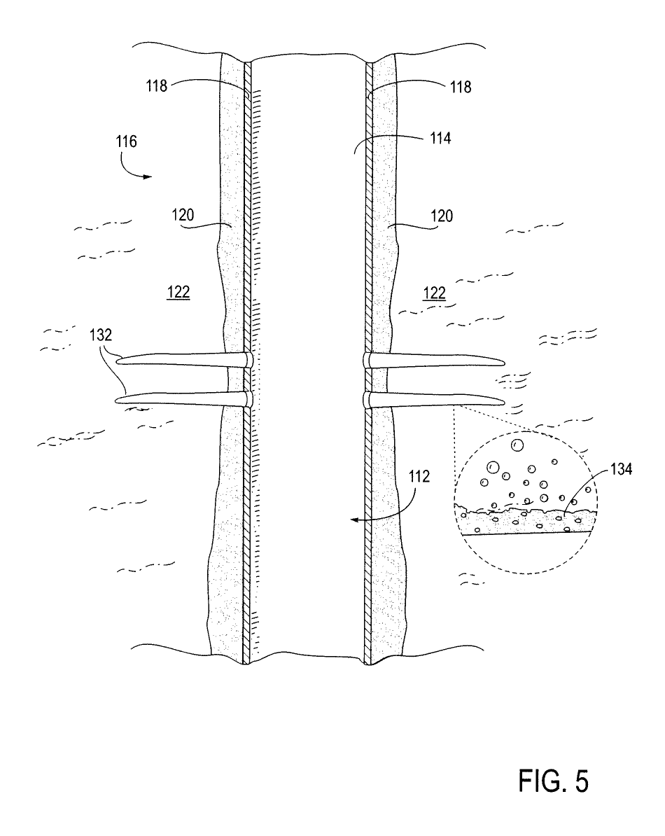

By way illustration, FIG. 5 illustrates the gradual degradation of the filter cake formed in perforations 132 by the solid particles within perforation fluid 114. Because of the special particle size distributions of the self degrading solids within perforations 132, perforations can be performed within multiple zones differentially pressured at operation 126 can be formed while providing instantaneous (or substantially instantaneous) well control, preventing crossflow between the differentially pressured zones, and alleviating or eliminating the need for post perforation stimulation.

For example, multiple intervals in a water or gas injection well may be perforated simultaneously where the intervals are several hundred feet apart and the pressure differential between the zones is several hundred pounds per square inch (psi). Conventional techniques typically perforate the lower zone with one perforating operation and pumping a fluid loss control pill of some type if there is excessive fluid loss before perforating the second zone. Once the second zone is perforated, a second fluid loss pill is pumped if there is excessive fluid loss. After the perforating operation is complete and the well is under control, the upper completion is placed in the well. Once the upper completion is in place and the rest of the well architecture is complete, removal of the fluid loss pills is required. Removal of the fluid loss pills is accomplished by either flowing reservoir fluids to the surface or placement of a chemical system such as an acid in the wellbore across both intervals to degrade the fluid loss pill components. Use of the self degrading fluid loss pill disclosed in this document eliminates the need for either method to remove the fluid loss pill. The self degrading fluid loss pill saves rig time, reduces formation damage, and/or provides other advantages.

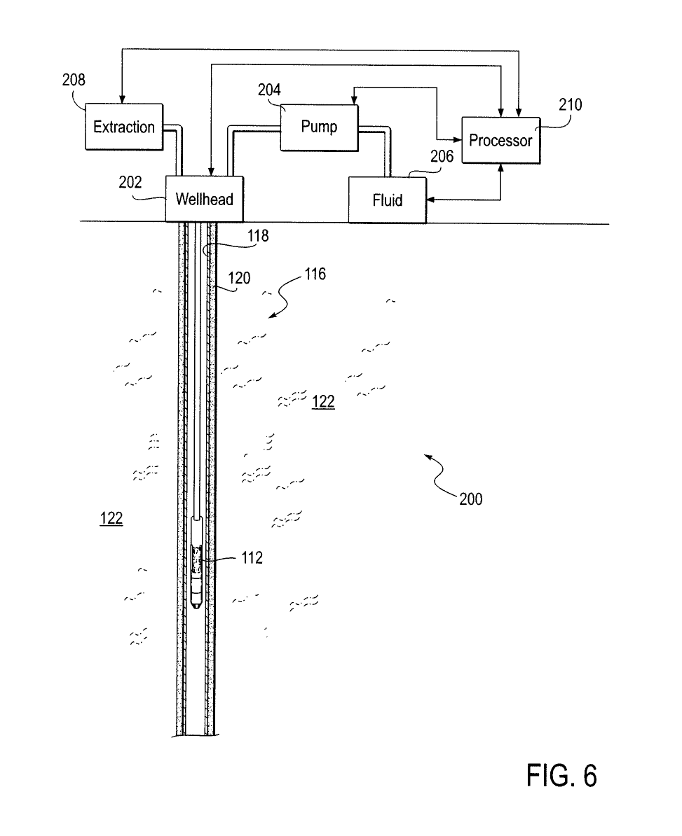

FIG. 6 illustrates a system 200 configured to perforate well-casing 118 of well 116 so that petrochemical fluids can be extracted from one or more geological formations 122 surrounding well 116. In particular, system 200 is configured to control fluid loss through the perforations while completions are set in well 116. This control is implemented through the use of a perforation fluid that comprises specially sized solid particles that are hydrolyzable. For example, system 200 may be configured to perform some or all of the operations of method 100 (shown in FIG. 1 and described herein). In some embodiments, system 200 may include one or more of a wellhead 202, a pump subsystem 204, perforation fluid storage 206, perforation gun 112, an extraction subsystem 208, one or more processors 210, and/or other components.

Well 116 is configured to facilitate extraction of petrochemical fluids from geological formations 122. Well 116 may include one or more of a borehole 212, well-casing 118, cement layer 120, and/or other components. Borehole 212 may be formed down through the earth, and may communicate the surface with geological formations 122, for purposes of guiding petrochemical fluids from geological formations 122 to the surface. Well-casing 118 is a large diameter pipe that is inserted into borehole 212, typically relatively soon after drilling. Well-casing 118 is inserted into borehole 212 to maintain the structural stability of borehole 212 and/or fluid isolation from geological formations 122 (and/or seawater in some cases). Cement layer 120 holds well-casing 118 in place and/or enhances the structural stability of well-casing 118 and provides a seal between the wellbore casing and the formation.

Wellhead 202 is configured to provide the structural and pressure-containing interface for drilling and/or production equipment. One purpose of wellhead 202 is to provide the suspension point and pressure seals for well 116 that run from the bottom of the sections (not shown) to the surface pressure control equipment. Once borehole 212 has been drilled, a Christmas tree (not shown) may be installed at wellhead 202. The Christmas tree may include isolation valves and choke equipment to control the flow of fluids within well 116. Wellhead 202 may be welded onto well-casing 118, to form an integral structure of well 116. Offshore, where wellhead 202 is located on the production platform (not shown) it is called a surface wellhead, and if located beneath the water then it is referred to as a subsea wellhead or mudline wellhead. During performance of a method similar to or the same as method 100 (shown in FIG. 1 and described herein), wellhead 202 may be configured to perform some or all of the functionality described with respect to operation 130 (shown in FIG. 1 and described herein).

Pump subsystem 204 is configured to pump fluid into and out of well 116 during creation of well 116. Such fluids may include, for example, drilling mud, brine, perforation fluid, and/or other fluids. The fluids may be distributed by pump subsystem 204 to different sections within well 116. The fluids may be distributed within well 116 to control various chemical, physical, and/or other properties within the various sections of well 116. The fluids may be pumped into and/or out of well 116 to control pressure within well 116. Pump subsystem 204 communicates with borehole 212 through wellhead 202. Pump subsystem 204 accesses the various fluids from fluid storage (e.g., from perforation fluid storage 206 and/or other fluid storage). Fluids received out of well 116 may be distributed to separate storage from fluids that will be pumped into well 116. During performance of a method similar to or the same as method 100 (shown in FIG. 1 and described herein), pump subsystem 204 may perform some or all of the functionality described with respect to operation 108 (shown in FIG. 1 and described herein).

Perforation fluid storage 206 is configured to store perforation fluid. The perforation fluid includes solid particles. In some embodiments, the perforation fluid may be created by an operation similar to or the same as operation 106 (shown in FIG. 1 and described herein). The solid particles may have particle sizes that correspond to the pore throat sizes of geological formations 122. The sizes of the pore throats and/or the corresponding particle sizes may be determined at operations similar to or the same as operations 102 and/or 104, respectively (shown in FIG. 1 and described herein). The perforation fluid held by perforation fluid storage 206 may be similar to or the same as perforation fluid 114 (shown in FIGS. 2-5 and described herein).

As was described above with respect to FIGS. 2-5, perforation gun 112 is configured to carry shaped charges, and to position the shaped charges within borehole 212 so that upon detonation the blasts will perforate well-casing 118 and cement 120 and penetrate into the formation. During operation, the perforation fluid from perforation fluid storage 206 is pumped into borehole 212 by pump subsystem 204 and perforation gun 112 is positioned within the perforation fluid. Upon perforation of well-casing 118 and cement 120, the solid particles in the perforation fluid bridge the pores of geological formations 122 to create a filter cake on the walls of the perforations to reduce fluids from entering geological formations 122 during setting of the completions within well 116. In some embodiments, perforation gun 112 may perform operations similar to or the same as operations 110 and/or 126 (shown in FIG. 1 and described herein).

Extraction subsystem 208 is configured to extract petrochemical fluids from well 116, once well 116 is completed and filter cake formed by the perforation fluid has been degraded. A variety of apparatus may be included in extraction subsystem 208, based on the type of fluid being extracted, the physical context of well 116, the environment surrounding well 116, and/or other parameters. It will be appreciated that for the purposes of this disclosure extraction subsystem 208 may include any such apparatus.

Processor 210 is configured to provide information processing capabilities in system 200. As such, processor 210 may include one or more of a digital processor, an analog processor, a digital circuit designed to process information, an analog circuit designed to process information, a state machine, and/or other mechanisms for electronically processing information. Although processor 210 is shown in FIG. 6 as a single entity, this is for illustrative purposes only. In some implementations, processor 210 may include a plurality of processing units. These processing units may be physically located within the same device, or processor 210 may represent processing functionality of a plurality of devices operating in coordination. Processor 210 may be configured to execute one or more computer program modules. Processor 210 may be configured to execute the modules by software; hardware; firmware; some combination of software, hardware, and/or firmware; and/or other mechanisms for configuring processing capabilities on processor 210. In some embodiments, processor 210 is configured to determine the pore throat size of geological formations 122 based on the input information described herein, determine the particle size(s) that correspond to the pore throat sizes of geological formations 122, to control one or more of perforation gun 112, wellhead 202, pump subsystem 204, extraction subsystem 208, and/or other components of system 200.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A method of perforating a well-casing in a well created for the extraction of petrochemical fluid, the method comprising:
obtaining a perforation fluid comprising solid particles suspended in a liquid, wherein the solid particles (i) having sizes that correspond to pore throat sizes of one or more geological formations through which the well-casing runs, and (ii) made up of a hydrolyzable material;
pumping the perforation fluid into a section of the well-casing that is to be perforated;
positioning a series of shaped charges within the perforation fluid such that detonation of the shaped charges will create perforations in the well-casing to communicate the interior of the well-casing with the formation exterior of the well-casing;
detonating the series of shaped charges to create the perforations in the well-casing;
controlling pressure within the well-casing such that the perforation fluid flows into the perforations, thereby causing the solid particles to plug the pores in the one or more geological formations on the exterior of the well-casing;
setting the completions within the well as the solid particles undergo hydrolysis;
extracting petrochemical fluids through the perforations after the solid particles have undergone hydrolysis.

2. The method of claim 1, wherein the solid particles are substantially the only particles included in the perforation fluid.

3. The method of claim 1, wherein the perforation fluid includes other solids, and wherein the ratio of volume of the solid particles to the volume of all solids is about or greater than 9/10.

4. The method of claim 1, further comprising determining the pore throat sizes of the one or more geological formations.

5. The method of claim 4, wherein obtaining the perforating fluid comprises adding solid particles having sizes that correspond to the determined port through sizes to the liquid.

6. The method of claim 1, wherein controlling pressure within the well-casing is accomplished with a wellhead installed at the well.

7. A system configured to perforate a well-casing in a well created for the extraction of petrochemical fluid, the system comprising:
a pump subsystem configured to pump a perforation fluid into a section of the well-casing that is to be perforated, the perforation fluid comprising solid particles suspended in a liquid, wherein the solid particles (i) having sizes that correspond to pore throat sizes of one or more geological formations through which the well-casing runs, and (ii) made up of a hydrolyzable material;
a perforation gun positioned within the perforation fluid such that detonation of a set of shaped charges carried by the perforation gun will create perforations in the well-casing to communicate the interior of the well-casing with the exterior of the well-casing into the formation;
a wellhead configured to control pressure within the well-casing such that the perforation fluid flows into the perforations subsequent to detonation of the charges cause the solid particles to plug the pores in the one or more geological formations on the exterior of the well-casing as completions are set within the well; and
a petrochemical extraction sub-system configured to extract petrochemical fluid through the perforations after the solid particles have undergone hydrolysis.

8. The system of claim 7, wherein the solid particles are substantially the only particles included in the perforation fluid.

9. The system of claim 7, wherein the perforation fluid includes other solids, and wherein the ratio of volume of the solid particles to the volume of all solids is about 9/10.

10. The system of claim 7, wherein the wellhead is a hydrostatic wellhead.

11. A method of creating a perforation fluid to be used in perforation of a well-casing in a well created for the extraction of petrochemical fluid, the method comprising:
obtaining pore throat sizes of one or more geological formations through which the well-casing runs;
determining a set of one or more particle sizes that correspond to the pore through sizes;
suspending solid particles in a liquid, wherein the solid particles (i) have the determined one or more particle sizes, and (ii) are made up of a hydrolyzable material.

12. The method of claim 11, wherein the solid particles are substantially the only particles included in the perforation fluid.

13. The method of claim 11, wherein the perforation fluid includes other solids, and wherein the ratio of volume of the solid particles to the volume of all solids is about 9/10.

14. The method of claim 11, further comprising determining the pore throat sizes of the one or more geological formations.

15. The method of claim 1, wherein the solid particles are made up of one or more self-degrading acid precursors.
